(19) United States
(12) Patent Application Publication
(10) Pub. No.: US 2015/0238047 A1
(43) Pub. Date: Aug. 27, 2015

(54) SURFACE TREATMENT METHOD FOR IRON-CAST PRODUCT AND IRON-CAST PRODUCT

(71) Applicants: OIGEN FOUNDRY CO., LTD, Oshu-shi (JP); INCORPORATED NATIONAL UNIVERSITY IWATE UNIVERSITY, Morioka-shi (JP)

(72) Inventors: Kuniko Oikawa, Oshu-shi (JP); Hideharu Oikawa, Oshu-shi (JP); Hitoshi Yashiro, Morioka-shi (JP)

(21) Appl. No.: 14/630,710

(22) Filed: Feb. 25, 2015

(30) Foreign Application Priority Data
Feb. 26, 2014 (JP) 2014-035563

(51) Int. Cl. A47J 36/02; B05D 3/02; B05D 7/14

(52) U.S. Cl. CPC A47J 36/02; B05D 7/14; B05D 3/0254

(57) ABSTRACT

A surface treatment method for an iron-cast product, which enables to give an anti-corrosion property to an iron-cast product and to produce a product having a rich texture by using only plant-derived materials suitable to kitchenware. A surface of the iron-cast product is applied with charcoal-containing oil, obtained by adding a plant-derived charcoal powder to vegetable oil, and heated and dried.

### BACKGROUND OF THE INVENTION

1. Field of the Invention

The present invention relates to a surface treatment method for an iron-cast product, by which an anti-corrosion property is given to an iron-cast product, and an iron-cast product having an anti-corrosion property.

2. Description of the Related Art

Kitchen-use iron-cast products are conventionally subjected to a variety of surface treatments and coating treatments for giving an anti-corrosion property and, for example, a coating treatment using chemical synthetic paints, an enameling process and Teflon (registered trademark) coating process, etc. are performed.

Particularly, when producing a kitchen-use iron-cast product like traditional Nambu ironware, also for the purpose of enhancing blackness to improve the texture as a product in addition to an anti-corrosion property, Japanese lacquer was applied and a baking treatment was performed formerly. But nowadays it has become general to perform a baking processing using a cashew paint instead of Japanese lacquer because of availability of the material and an improvement of productivity.

As to kitchen-use iron-cast products, however, demands for products subjected to an anti-corrosion treatment using plant-derived materials instead of a chemical surface treatment have been increasing internationally in terms of security and safety. For example, conventionally, some kitchen-use iron-cast products require seasoning with vegetable oil when used on site to prevent corrosion, and it is possible to consider to introduce the idea of seasoning to a production process in iron-cast factories.

In a surface treatment method of simply applying vegetable oil and firing, however, it comes off easily due to low adhesiveness, and the anti-corrosion property is liable to be lost, which is disadvantageous. There also is a disadvantage that rich black texture cannot be obtained by the surface treatment of only burning vegetable oil compared with products produced in the conventional method.

### SUMMARY OF THE INVENTION

The present invention was made in consideration of the disadvantages above and has as an object thereof to provide a surface treatment method for an iron-cast product, by which an anti-corrosion property can be given to an iron-cast product and a product with a rich texture can be produced by using only plant-derived materials suitable to kitchenware. Another object of the present invention is to provide an iron-cast product having a high anti-corrosion property and rich texture by using only plant-derived materials suitable to kitchenware.

To attain the objects above, firstly, according to the present invention, there is provided a surface treatment method for an iron-cast product, wherein a surface of an iron-cast product is applied with charcoal-containing oil, obtained by adding a plant-derived charcoal powder to vegetable oil, and heated and dried (Invention 1).

An iron-cast product in the present application is made of normal cast iron having a composition including C: 2.5 to 4.0%, Si: 0.5 to 3.0%, Mn: 0.4 to 1.0%, P: 0.03 to 0.8% and S: 0.05 to 0.12% based on the weight ratio. The iron-cast product here is a mold-cast item, obtained by pouring melt pig iron or other material into a casting mold, such as a sand molt, then, releasing it from the mold, removing mold sand, and finishing with burr removal and polishing, etc., further subjected to a surface treatment.

The present inventors have been committed themselves to study on a method of giving an anti-corrosion property to an iron-cast product by using only plant-derived materials and found that an anti-corrosion property of an iron-cast product was improved by adopting a surface treatment method of using charcoal-containing oil, obtained by adding a plant-derived charcoal powder to vegetable oil, and heating and drying when compared with the method of simply applying vegetable oil to an iron-cast product. It is considered that this is because cracks on a coat is suppressed due to formation of a polymerized coat of vegetable oil containing a plant-derived charcoal powder, consequently, a penetration speed of the air and water to the coat decreases. Also, due to an effect of the added charcoal powder, an iron-cast product after subjected to the surface treatment obtains deeper blackness compared with an iron-cast product simply applied with vegetable oil and heated and dried.

According to the invention above (Invention 1), it is possible to give a high anti-corrosion property to the iron-cast product by using only plant-derived materials, such as vegetable oil and plant-derived charcoal powder, and to produce an iron-cast product having deeper blackness and a rich texture.

In the invention above (Invention 1), preferably, the surface of the iron-cast product is applied with the vegetable oil and heated and dried before being applied with the charcoal-containing oil (Invention 2).

According to the invention above (Invention 2), polymerized coats formed on the surface of the iron-cast product come to have a double-layered structure and a higher anti-corrosion property can be given to the iron-cast product.

Alternatively, in the invention above (Invention 1), an oxide coat may be formed on the surface of the iron-cast product before application of the charcoal-containing oil (Invention 3).

According to the invention above (Invention 3), since the oxide coat itself enhances an anti-corrosion property and a polymerized coat is formed while impregnating the oxide coat with vegetable oil, it is possible to enhance the anti-corrosion property even more.

Also, in the invention above (Invention 2), preferably, an oxide coat is formed on the surface of the iron-cast product before application of the vegetable oil (Invention 4).

According to the invention above (Invention 4), vegetable oil polymerized coats formed on the surface of the iron-cast product come to have a double-layered structure and the polymerized coats are formed while impregnating the oxide coat with vegetable oil, consequently, a further higher anti-corrosion property can be obtained.

In the inventions above (Inventions 1 to 4), preferably, the plant-derived charcoal powder is a bamboo charcoal powder or a charcoal powder (Invention 5). Also, in the inventions above (Inventions 1 to 5), preferably, the vegetable oil is linseed oil, olive oil, canola oil or grape seed oil (Invention 6).

Secondary, there is provided an iron-cast product, wherein a surface of the iron-cast product has a coat formed thereon by being applied with charcoal-containing oil, obtained by adding a plant-derived charcoal powder to vegetable oil, and heated and dried (Invention 7).

By the surface treatment method of applying charcoal-containing oil obtained by adding plant-derived charcoal powder to vegetable oil and heating and drying, a polymerized coat of vegetable oil containing plant-derived charcoal powder is formed on a surface of the iron-cast product. Also, the iron-cast product after subjected to the surface treatment exhibits deeper blackness due to an effect of the added charcoal powder compared with an iron-cast product simply applied with vegetable oil and heated and dried. Therefore, according to the invention above (Invention 7), an iron-cast product having a high anti-corrosion property can be obtained and the iron-cast product can have a rich texture with deep blackness by using only plant-derived materials, which are vegetable oil and plant-derived charcoal powder.

In the invention above (Invention 7), preferably, a preliminary coat is formed by applying the vegetable oil to the surface of the iron-cast product and heating and drying (Invention 8).

According to the invention above (Invention 8), since polymerized coats of vegetable oil formed on the surface of the iron-cast product have a double-layered structure, the iron-cast product having a higher anti-corrosion property can be attained.

Alternatively, in the invention above (Invention 7), an oxide coat may be formed on an inner side of the coat (Invention 9).

According to the invention above (Invention 9), since the oxide coat itself enhances an anti-corrosion property and a polymerized coat is formed while impregnating the oxide coat with vegetable oil, it is possible to enhance the anti-corrosion property even more.

In the invention above (Invention 8), preferably, an oxide coat is formed on an inner side of the preliminary coat (Invention 10).

According to the invention above (Invention 10), polymerized coats of vegetable oil formed on the surface of the iron-cast product come to have a double-layered structure and the polymerized coats are formed while impregnating the oxide coat with vegetable oil, consequently, a further higher anti-corrosion property can be obtained.

In the inventions above (Inventions 7 to 10), preferably, the plant-derived charcoal powder is a bamboo charcoal powder or a charcoal powder (Invention 11). Also, in the inventions above (Inventions 7 to 11), preferably, the vegetable oil is linseed oil, olive oil, canola oil or grape seed oil (Invention 12).

According to the surface treatment method for iron-cast products of the present invention, it is possible to give an iron-case product an anti-corrosion property and to produce a product having a rich texture by using only plant-derived materials suitable to kitchenware. Also, according to the iron-cast product of the present invention, it is possible to provide an iron-cast product having a high anti-corrosion property and a rich texture by using only plant-derived materials suitable to kitchenware.

### BRIEF DESCRIPTION OF DRAWINGS

These and other objects and features of the present invention will become clearer from the following description of the preferred embodiments given with reference to the attached drawings, in which:

FIG. 1 is a flow diagram showing a surface treatment method for an iron-cast product according to an embodiment of the present invention;

FIG. 2 is a schematic diagram showing a measurement method of a corrosion potential in examples of the present invention; and

FIG. 3 is a graph showing measurement results of examples and comparative examples of the present invention.

### DESCRIPTION OF THE PREFERRED EMBODIMENT

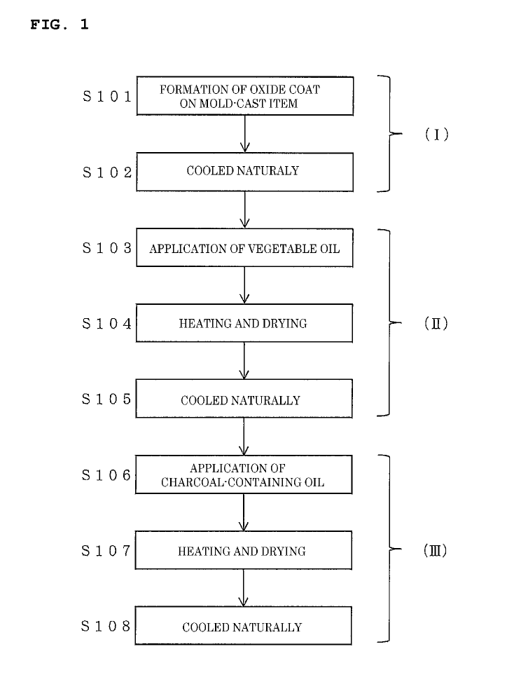

Below, an embodiment of the present invention will be explained based on the drawings. A flow of the surface treatment method for an iron-cast product according to the present embodiment will be explained with reference to FIG. 1 first. A surface treatment method for an iron-cast product here is to perform a surface treatment on a mold-cast item obtained by pouring melted pig iron or other material to a casting mold, such as a sand mold, then, releasing it from the mold, removing casting sand, and finishing with burr removal and polishing, etc. so as to obtain an iron-cast product.

The surface treatment method for an iron-cast product according to the present embodiment comprises three steps: (I) an oxide coat formation step, (II) a preliminary coat formation step and (III) a formation step of a polymerized coat containing a plant-derived carbon powder. As shown in FIG. 1, in the surface treatment method for an iron-cast product according to the present embodiment, first, an oxide coat is formed on a surface of a mold-cast item produced through general steps (S101). A method of forming an oxide coat is not particularly limited and, for example, an electric furnace may be used or a so-called kiln method of steaming and baking at approximately 800° C. by charcoal fire (using charcoal) for 30 to 40 minutes or so may be used. When using an electric furnace, a temperature in a furnace chamber thereof is set to 400 to 700° C., and a heating treatment is preferably performed with heating time of 10 minutes to 2 hours, and more preferably with heating temperature at 500 to 600° C. for 30 minutes to 1 hour. Alternatively, it may be formed by filling the electric furnace with an inert gas, then controlling an oxygen concentration to 0.1 to 5% to perform a heating treatment and subsequently cooling in the air. During this, a heating treatment is performed preferably with a temperature at 700 to 930° C. in the chamber of the electric furnace and heating treatment time of 12 to 15 minutes, and more preferably the oxygen concentration is controlled to 0.5 to 5%.

Now returning back to the surface treatment method of an iron-cast product according to the present embodiment, a mold-cast item having been heated and subjected to the oxide coat forming treatment is cooled naturally to the normal temperature next (S102), and vegetable oil is applied to the whole surface of the mold-cast item having an oxide coat formed thereon (S103). As the vegetable oil, for example, linseed oil, olive oil, canola oil and grape seed oil, etc. may be used and, among those, use of linseed oil is particularly preferable. Also, application of vegetable oil to the mold-cast item surface may be done, for example, by using a brush or spray. An application amount of the vegetable oil is preferably 0.1 to 10 mg/cm² in a dried weight and 1 to 5 mg/cm² is more preferable.

After applying vegetable oil, the mold-cast item is placed in a normally-used heating device, such as an electric furnace and gas furnace, and a heating and drying treatment is performed so that volatile components in the vegetable oil evaporate (S104).

In the heating and drying treatment, the heating temperature is preferably 250 to 320° C. and particularly preferably 270 to 300° C. When the heating temperature is lower than 250° C., process of polymerization takes extremely long time and unfavorable gloss is liable to remain on the product, while when 320° C. or higher, corrosion resistance declines remarkably. The heating time here is preferably 10 minutes to 2 hours depending on the heating temperature, and 30 minutes to 1 hour at 270 to 300° C. is particularly preferable. When the heating time is in short, polymerization becomes insufficient and unfavorable gloss remains, while when it is too long, the corrosion resistance declines.

As a result of performing the heating and drying treatment as explained above, a polymerized coat of vegetable oil is formed on the mold-cast item surface. In the present embodiment, since an oxide coat is already formed on the mold-cast item surface, it comes to the state where the polymerized coat of vegetable oil is formed on the oxide coat. During this, since the polymerized coat is formed while impregnating the oxide coat with vegetable oil, the anti-corrosion property is enhanced more.

The mold-cast item having been applied with vegetable oil and finished with the heating and drying treatment is cooled naturally to the normal temperature (S105). The state here is that an oxide coat and a vegetable oil polymerized coat as a preliminary coat are formed on the surface of the naturally cooled mold-cast item. Subsequently, the whole surface of the mold-cast item (that is, the outer side of the preliminary coat) is applied with charcoal-containing oil obtained by adding a plant-derived charcoal powder to vegetable oil (S106). As the plant-derived charcoal powder, for example, bamboo charcoal, Bincho charcoal or other charcoal formed into powder may be used. Among them, it is particularly preferable to use a bamboo charcoal powder, which is also edible, having an average particle diameter of 5 to 20 μm or so. Whether a bamboo powder or a charcoal powder is edible or not may be decided, for example, based on whether it is approved as a food additive or not.

Blending ratio of the vegetable oil to the plant-derived charcoal powder is preferably 20:1 to 2:1 in the weight ratio. A desired corrosion resistance and blackness cannot be obtained when the charcoal powder is too little, while workability and adhesiveness decline when the charcoal powder is too much. Particularly, what obtained by adding a bamboo charcoal powder to linseed oil is preferable as charcoal-containing oil, and the optimal blending ratio in this case is 10:1 to 3:1 in the weight ratio. Note that application of the charcoal-containing oil may be done, for example, by using a brush or spray in the same way as in vegetable oil application.

An application amount of the charcoal-containing oil is preferably 0.1 to 10 mg/cm² and more preferably 1 to 5 mg/cm² based on the dry weight.

After applying the charcoal-containing oil, the mold-cast item is placed in a normally-used heating device, such as an electric furnace and gas furnace, and a heating and drying treatment is performed to vaporize volatile components in the charcoal-containing oil (S107).

In this heating and drying treatment, the heating temperature is preferably 250 to 320° C. and particularly preferably 270 to 300° C. When the heating temperature is lower than 250° C., process of polymerization takes extremely long time and unfavorable gloss is liable to remain on the product, while when higher than 320° C., corrosion resistance declines remarkably. The heating time here is preferably 10 minutes to 2 hours depending on the heating temperature, and 30 minutes to 1 hour at 270 to 300° C. is particularly preferable. When the heating time is in short, polymerization becomes insufficient and unfavorable gloss remains, while when it is too long, the corrosion resistance declines.

As a result of the heating and drying treatment as explained above, a polymerized coat of vegetable oil containing a plant-derived charcoal powder is formed on the surface of the mold-cast item. In the present embodiment, since an oxide coat and a vegetable oil polymerized coat as a preliminary coat are already formed in an overlapping way on the mold-cast item, it comes to the state where the polymerized coat of vegetable oil containing a plant-derived charcoal powder is formed on the preliminary coat in an overlapping way.

When the mold-cast item applied with charcoal-containing oil and finished with the heating and drying treatment is cooled naturally to the normal temperature (S108), an iron-cast product finished with the surface treatment is obtained. The iron-cast product is in the state where the oxide coat, the vegetable oil polymerized coat as a preliminary coat and the polymerized coat of vegetable oil containing a plant-derived charcoal powder are formed on a surface thereof in this order toward outside. As a result that the vegetable oil polymerized coats formed on the iron-cast product surface have a two-layer structure and that the polymerized coat is formed while impregnating the oxide coat with vegetable oil as explained above, it becomes possible to produce an iron-cast product having an extremely high anti-corrosion property.

As above, an explanation was made on the surface treatment method for an iron-cast product according to the present embodiment, however, the present invention is not limited to the embodiment above and may be modified in a various ways. For example, in the present embodiment, (I) the oxide coat formation step (S101 and S102), (II) the preliminary coat formation step (S103, S104 and S105) and (III) a formation step of a polymerized coat containing a plant-derived carbon powder (S106, S107 and S108) are performed in this order, however, (I) the oxide coat formation step and (II) the preliminary coat formation step are not always necessary in the invention of the present application. Therefore, only (II) the preliminary coat formation step and (III) the formation step of a polymerized coat containing a plant-derived carbon powder may be performed without performing (I) the oxide coat formation step, or only (I) the oxide coat formation step and (III) the formation step of a polymerized coat containing a plant-derived carbon powder may be performed without performing (II) the preliminary coat formation step. Alternately, an iron-cast product having a high anti-corrosion property can be obtained by only performing (III) the formation step of a polymerized coat containing a plant-derived carbon powder without performing (I) the oxide coat formation step and (II) the preliminary coat formation step. Furthermore, each step is not limited to be performed only one time but may be performed for a plurality of times.

### EXAMPLES

Below, the present invention will be explained more specifically by taking examples and comparative examples. In the examples and comparative examples, a variety of surface treatments were performed on later-explained iron-cast test pieces while changing the condition, and an corrosion potential was measured by measuring an electrochemical characteristic value of each test piece after the surface treatment.

[Iron-Cast Test Piece]

Iron-cast test pieces were produced as explained below. First, target components were set to C: 3.8%, Si: 2.2%, Mn: 0.5%, P: 0.1% and S: 0.1% and mixed with 30% of pig iron, 20% of steel, 50% of steel scraps from production lines, FeSi and FeMn, then, fed to a melting furnace to melt. Subsequently, a mold is formed by using a molding machine, melted metal was poured into a released mold, the metal was released from the mold, casting sand was removed by a shot blast, and the resultant was finished with burr removal and polishing, so that a plate-shaped mold-cast item was produced. The plate-shaped mold-cast item was cut into approximately 5 cm×2.5 cm and used as iron-cast test pieces.

[Measurement Method of Corrosion Potential]

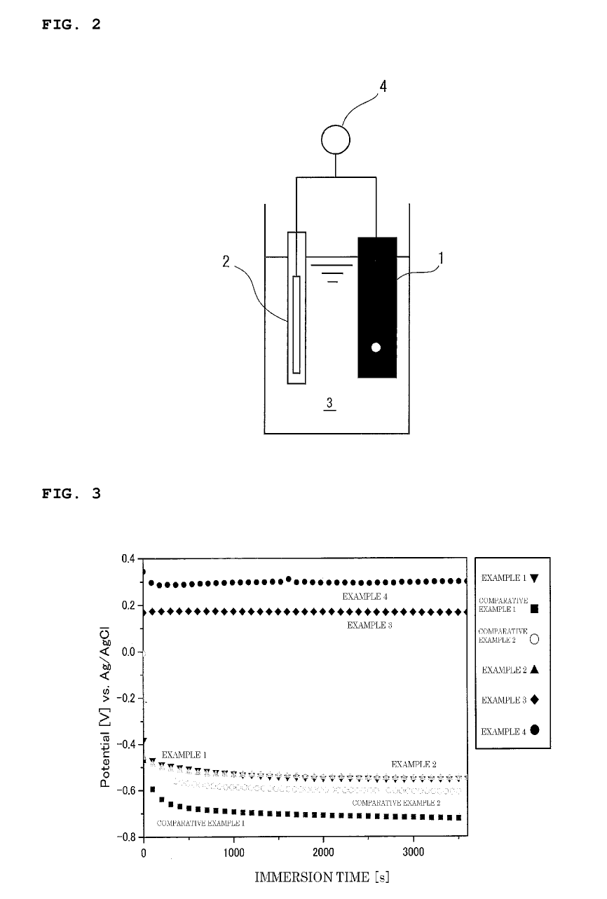

As shown in FIG. 2, vinyl tape having a hole (having an area of 0.28 cm²) was put on a surface of an iron-cast test piece, so that a predetermined area was exposed, and the piece was immersed in a sodium chloride aqueous solution (concentration: 0.5 mol/L) at the room temperature. A market-available silver-silver chloride reference electrode was immersed in the same solution, and a potential difference between the two electrodes was measured for one hour by using a market-available potentiometer.

### Example 1

On the overall surface of an iron-cast test piece, charcoal-containing oil obtained by adding edible bamboo charcoal (particle diameter: 10 μm) in an amount of 6 g to linseed oil in an amount of 18 g was applied and a heating and drying treatment was performed at a heating temperature of 280° C. for 1 hour. After that, it was cooled naturally to the normal temperature, and a corrosion potential (corrosion resistance) of the iron-cast test piece was measured by the method explained above. The measurement result is shown in FIG. 3.

### Comparative Example 1

A corrosion potential of an iron-cast test piece not subjected to any surface treatment was measured by the method above. The measurement result is shown in FIG. 3.

### Comparative Example 2

On the overall surface of an iron-cast test piece, linseed oil was applied and a heating and drying treatment was performed at a heating temperature of 280° C. for 1 hour. After that, it was cooled naturally to the normal temperature, and a corrosion potential of the iron-cast test piece was measured by the method explained above. The measurement result is shown in FIG. 3.

### Example 2

On the overall surface of an iron-cast test piece, linseed oil was applied and a heating and drying treatment was performed at a heating temperature of 280° C. for 1 hour. After the treatment, it was cooled naturally to the normal temperature, charcoal-containing oil obtained by adding edible bamboo charcoal (particle diameter: 10 μm) in an amount of 6 g to linseed oil in an amount of 18 g was applied to the iron-cast test piece, and a heating and drying treatment was performed at a heating temperature of 280° C. for 1 hour. Subsequently, it was cooled naturally to the normal temperature, and a corrosion potential of the iron-cast test piece was measured by the method explained above. The measurement result is shown in FIG. 3.

### Example 3

An iron-cast test piece was carried on a tray to be placed in an electric furnace, an atmosphere in the furnace was replaced with an inert gas and an oxygen partial pressure was set to 1% or less, a heating treatment was performed at a heating temperature of 500° C. for 1 hour (+retention time for 15 minutes), after that, the tray was taken out and cooled naturally outside the furnace, so that an oxide coat was formed. Subsequently, the overall surface of an iron-cast test piece was applied with charcoal-containing oil obtained by adding edible bamboo charcoal (particle diameter: 10 μm) in an amount of 6 g to linseed oil in an amount of 18 g, and a heating and drying treatment was performed thereon at a heating temperature of 280° C. for 1 hour. After that, it was cooled naturally to the normal temperature, and a corrosion potential of the iron-cast test piece was measured by the method explained above. The measurement result is shown in FIG. 3.

### Example 4

An oxide coat was formed on an iron-cast test piece in the same way as in the example 3, then, the overall surface of an iron-cast test piece was applied with linseed oil and a heating and drying treatment was performed thereon at a heating temperature of 280° C. for 1 hour. After the treatment, the iron-cast test piece, which was cooled naturally to the normal temperature, was applied with charcoal-containing oil obtained by adding edible bamboo charcoal (particle diameter: 10 μm) in an amount of 6 g to linseed oil in an amount of 18 g and subjected to a heating and drying treatment at a heating temperature of 280° C. for 1 hour. Subsequently, it was cooled naturally to the normal temperature, and a corrosion potential of the iron-cast test piece was measured by the method explained above. The measurement result is shown in FIG. 3.

When referring to FIG. 3, it is learned that, when compared with the iron-cast test pieces in the comparative examples 1 and 2, those in the examples 1, 2, 3 and 4 exhibited improved corrosion resistance. Among them, corrosion resistance of the iron-cast test piece was largely improved in the case of forming an oxide coat (the examples 3 and 4), and corrosion resistance was dramatically improved in the case of forming double coats of the polymerized coat (preliminary coat) of linseed oil and the polymerized coat of charcoal-containing oil composed of linseed oil and a bamboo charcoal powder on the outer side of the oxide coat (the example 4).

### EXPLANATION OF NUMERICAL REFERENCES

1 . . . iron-cast test piece
2 . . . silver-silver chloride reference electrode
3 . . . sodium chloride solution
4 . . . potentiometer

1. A surface treatment method for an iron-cast product, wherein a surface of an iron-cast product is applied with charcoal-containing oil, obtained by adding a plant-derived charcoal powder to vegetable oil, and heated and dried.

2. The surface treatment method for an iron-cast product according to claim 1, wherein the surface of the iron-cast product is applied with the vegetable oil and heated and dried before being applied with the charcoal-containing oil.

3. The surface treatment method for an iron-cast product according to claim 1, wherein an oxide coat is formed on the surface of the iron-cast product before application of the charcoal-containing oil.

4. The surface treatment method for an iron-cast product according to claim 2, wherein an oxide coat is formed on the surface of the iron-cast product before application of the vegetable oil.

5. The surface treatment method for an iron-cast product according to claim 1, wherein the plant-derived charcoal powder is a bamboo charcoal powder or a charcoal powder.

6. The surface treatment method for an iron-cast product according to claim 1, wherein the vegetable oil is linseed oil, olive oil, canola oil or grape seed oil.

7. An iron-cast product, wherein a surface of the iron-cast product has a coat formed thereon by being applied with charcoal-containing oil obtained by adding a plant-derived charcoal powder to vegetable oil and heated and dried.

8. The iron-cast product according to claim 7, wherein, on an inner side of the coat, a preliminary coat is formed by applying the vegetable oil to the surface of the iron-cast product and heating and drying.

9. The iron-cast product according to claim 7, wherein an oxide coat is formed on an inner side of the coat.

10. The iron-cast product according to claim 8, wherein an oxide coat is formed on an inner side of the preliminary coat.

11. The iron-cast product according to claim 7, wherein the plant-derived charcoal powder is a bamboo charcoal powder or a charcoal powder.

12. The surface treatment method for an iron-cast product according to claim 7, wherein the vegetable oil is linseed oil, olive oil, canola oil or grape seed oil.

13. The surface treatment method for an iron-cast product according to claim 2, wherein the plant-derived charcoal powder is a bamboo charcoal powder or a charcoal powder.

14. The surface treatment method for an iron-cast product according to claim 2, wherein the vegetable oil is linseed oil, olive oil, canola oil or grape seed oil.

15. The iron-cast product according to claim 8, wherein the plant-derived charcoal powder is a bamboo charcoal powder or a charcoal powder.

16. The surface treatment method for an iron-cast product according to claim 8, wherein the vegetable oil is linseed oil, olive oil, canola oil or grape seed oil.

17. The surface treatment method for an iron-cast product according to claim 3, wherein the plant-derived charcoal powder is a bamboo charcoal powder or a charcoal powder.

18. The surface treatment method for an iron-cast product according to claim 3, wherein the vegetable oil is linseed oil, olive oil, canola oil or grape seed oil.

19. The iron-cast product according to claim 9, wherein the plant-derived charcoal powder is a bamboo charcoal powder or a charcoal powder.

20. The surface treatment method for an iron-cast product according to claim 9, wherein the vegetable oil is linseed oil, olive oil, canola oil or grape seed oil.
